(19) United States
(12) Patent Application Publication
(10) Pub. No.: US 2008/0228759 A1
(43) Pub. Date: Sep. 18, 2008

(54) ELECTRONIC BULLETIN BOARD APPARATUS, COMPUTER-READABLE STORAGE MEDIUM HAVING AN ELECTRONIC BULLETIN BOARD CONTROL PROGRAM AND ELECTRONIC BULLETIN BOARD CONTROL METHOD

(76) Inventors: Koji Maruhashi, Kawasaki (JP); Yoshio Nakao, Kawasaki (JP); Hiroshi Yamakawa, Kawasaki (JP); Masahiro Asaoka, Kawasaki (JP); Nobuo Watanabe, Kawasaki (JP)

Correspondence Address: STAAS & HALSEY LLP, SUITE 700, 1201 NEW YORK AVENUE, N.W., WASHINGTON, DC, 20005, US

(21) Appl. No.: 12/042,454

(22) Filed: Mar. 5, 2008

(30) Foreign Application Priority Data
Mar. 16, 2007 (JP) 2007-069585

(51) Int. Cl. G06F 7/06; G06F 3/048; G06F 17/30

(52) U.S. Cl. 707/5; 715/764; 707/1; 707/E17.017

(57) ABSTRACT

An electronic bulletin board apparatus and method enabling a second user to answer a question of a first user using an answer input picture, including generating guide information for guiding the second user to an answer input picture as a guide destination picture through which to respond to a first question of the first user based on a second question that is similar to the first question, and posting the guide information in an answer input picture as a posting destination picture through which to respond to the second question. The electronic bulletin board apparatus and method displays the guide destination picture based on the guide information selected by the second user among pieces of guide information posted in the posting destination picture

### CROSS-REFERENCE TO RELATED APPLICATIONS

This application is related to and claims the benefit of priority from Japanese Patent Application No. 2007-069585, filed on Mar. 16, 2007, the entire contents of which are incorporated herein by reference.

### BACKGROUND

### 1. Field

The present invention relates to a question-answer-type electronic bulletin board service which provides a place (venue) for information exchange.

### SUMMARY

The disclosed electronic bulletin board apparatus enables a second user to answer a question of a first user using an answer input picture. The electronic bulletin board apparatus includes generating guide information for guiding the second user to an answer input picture as a guide destination picture through which to respond to a first question of the first user based on a second question that is similar to the first question, posting the guide information in an answer input picture as a posting destination picture through which to respond to the second question, and displaying the guide destination picture based on the guide information selected by the second user among pieces of guide information posted in the posting destination picture.

The disclosed electronic bulletin board control method includes generating guide information for guiding the second user to an answer input picture as a guide destination picture through which to respond to a first question of the first user, based on a second question that is similar to the first question, posting the guide information in an answer input picture as a posting destination picture through which to respond to the second question, and displaying the guide destination picture based on the guide information selected by the second user among pieces of guide information posted in the posting destination picture

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a configuration of an electronic bulletin board system;

FIG. 2 illustrates a conceptual configuration of an electronic bulletin board system;

FIG. 3 illustrates an exemplary data structure of an answer history;

FIG. 4 illustrates an exemplary data structure of an unanswered guide information history;

FIG. 5 illustrates an exemplary data structure of a posting information database;

FIG. 6 illustrates an exemplary data structure of a guide information queue;

FIG. 7 illustrates a process executed by an electronic bulletin board control section;

FIG. 8 illustrates details of a guide information generation process;

FIG. 9 illustrates an operation flow of an electronic bulletin board control section which corresponds to a guide information generation process;

FIG. 10 illustrates a detailed flow of a process for acquiring guide information posting destination candidates;

FIG. 11 illustrates details of a guide information posting;

FIG. 12 illustrates an operation flow of an electronic bulletin board control section which corresponds to a guide information posting process;

FIG. 13 illustrates details of a process for guiding an information holder to a prescribed question;

FIG. 14 illustrates a process for displaying unanswered guide information in a guide destination picture;

FIG. 15 illustrates details of a guide information posting finishing process;

FIG. 16 illustrates an operation flow of an electronic bulletin board control section which corresponds to a guide information posting finishing process;

FIG. 17 illustrates a process for displaying a past answer history in a reusable form;

FIG. 18 is a block diagram illustrating a hardware configuration of a server as an exemplary implementation of an electronic bulletin board control system;

FIG. 19 illustrates a typical electronic bulletin board service in which a number of answers to questions in one category is very different from that in another category; and

FIG. 20 exemplifies how a typical question-answer-type electronic bulletin board service is used.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

In recent years, with the development of network technologies such as the Internet, many question-answer-type electronic bulletin board services have come into being which are intended to provide a place for information exchange. Among famous Japanese services are “Oshiete (Teach me)! Goo” (http://oshiete.goo.ne.jp/) and “OKWave” (http://okwave.jp/). And among famous U.S. services is “Answerbag” (http://www.answerbag.com/).

These services allow users to complement each other's knowledge in such a manner that a user who wants information and a user (hereinafter referred to as “information holder”) who has information applicable as an answer to exchange information through a bulletin board.

For example, according to an electronic bulletin board service provided based on region(s), it is common that residents in a certain region exchange information of good stores, hospitals, etc. located in the particular region. In this type of bulletin board service, for example, a user (hereinafter referred to as “questioner”) who wants information related to treatment of a disease may write or post a question such as “Tell me a good hospital capable of treating a disease X” on a bulletin board and may be provided with, by another user of the bulletin board who has related information, such information as a good hospital worth introduction and reputation of a candidate hospital.

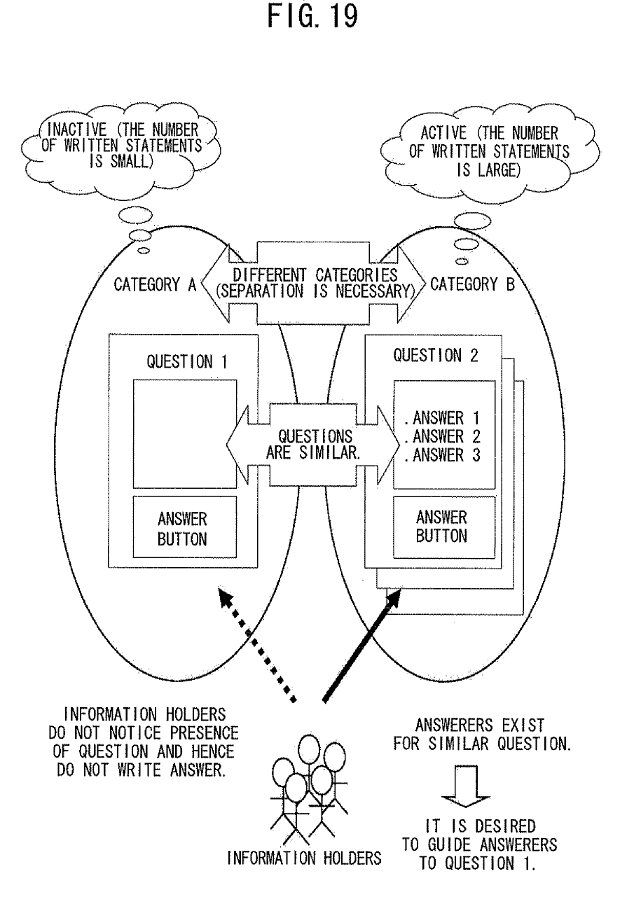

FIG. 19 illustrates an electronic bulletin board service in which a number of answers to questions in one category are very different from that of another category. As shown in FIG. 19, in many existing electronic bulletin board services, plural bulletin boards of different categories of questions handle questions and answers independently.

In such bulletin board services, there may occur a high-activity category in which questions are written frequently and a low-activity category in which questions are not written very frequently. In general, a high-activity category tends to attract many users. Therefore, it is highly probable that an information holder who has noticed the presence of a written question immediately writes an answer. On the other hand, in a low-activity category, it is very likely that no one becomes aware of the presence of a question and the question is left unanswered.

Therefore, there may occur a situation that, of two similar questions written in two categories, the question (question 2) written in a high-activity category B is answered but the question (question 1) written in another, low-activity category A is not answered.

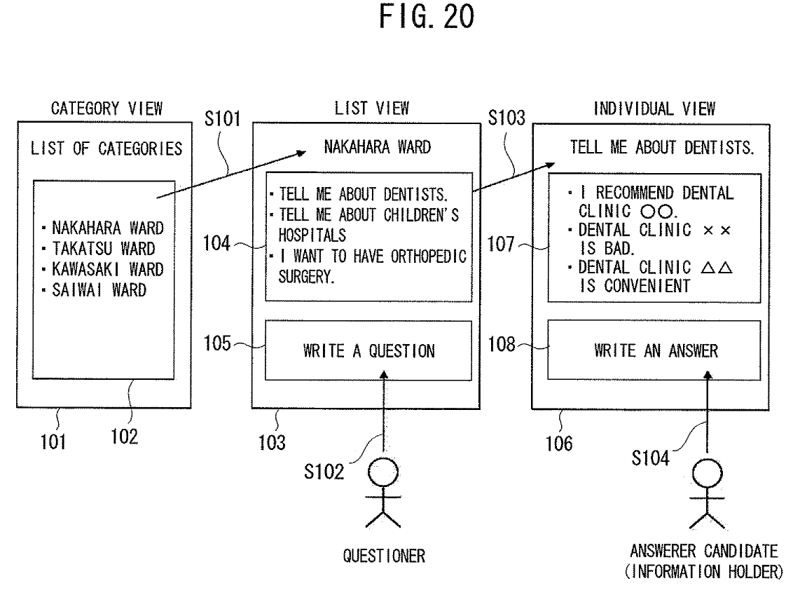

In this case, an information holder who answers question 2 may be a candidate to answer question 1. Therefore, it is highly probable that an answer to question 1 can also be obtained if that information holder is prompted to answer (or presented with) question 1. This problem will be described in a detailed manner using a typical electronic bulletin board shown in FIG. 20.

FIG. 20 exemplifies how a typical question-answer-type electronic bulletin board service is used. For example, the electronic bulletin board shown in FIG. 20 is composed of a picture (called “category view”) 101 in which a list 102 of question categories by regions is displayed, a picture (called “list view”) 103 in which a list 104 of questions in ascertain category is displayed, and a picture (called “individual view”) 106 in which a list 107 of an individual question and corresponding answer is displayed.

A user can use this electronic bulletin board service by accessing a prescribed server on a network from a user terminal (e.g., personal computer, cell phone, or other similar device).

First, at operation S101, a user causes a terminal to display the category view 101 and selects a category that is suitable for a desired purpose from the category list 102, whereupon a list view 103 of the selected category is displayed.

A list 104 of questions in the selected category is shown in the list view 103. A question input form 105 for inputting a question is also displayed in the list view 103. If a user of the electronic bulletin board service wants to input a question (the user becomes a questioner), at operation S102 the user inputs a question using, for example, the question input form 105 in the list view 103.

Or the user selects a subject question from the question list 104 at operation S103, whereupon an individual view 106 corresponding to the selected question is displayed.

A list 107 of answers corresponding to the selected question is displayed in the individual view 106. An answer input form 108 for inputting an answer is also displayed in the individual view 106. If a user of the electronic bulletin board service wants to answer a question (the user becomes an information holder), at operation S104 the user inputs an answer using, for example, the answer input form 108 in the individual view 106.

In the thus-configured bulletin boards, a phenomenon frequently occurs that the activity varies depending on the category (the categories correspond to the respective regions) because of uneven distribution of residences of users of the bulletin board service and other factors. For example, there may occur a phenomenon that among the categories in the category list 102 of the category view 101 high activity is associated with the category “Nakahara ward” (many users reside in the Nakahara ward) but the activity associated with the category “Takatsu ward” (the Takatsu-ward is geographically adjacent to the Nakahara ward) is low.

Assume that a question “Tell me about dentists” has been written in the high-activity “Nakahara ward” category. It is highly probable that an information holder having information relating to dentists in and around the Nakahara ward reads the question and writes a corresponding answer. On the other hand, in the low-activity “Takatsu ward” category, the probability is low that an answer to a similar question “Who is a good dentist?” is written.

It is highly probable that the information holder who answers the question relating to dentists in the Nakahara ward also has information relating to dentists in the Takatsu ward which is geographically adjacent to the Nakahara ward. Therefore, it is highly probable that the information holder who answers the question relating to dentists in the Nakahara ward is also able to write an answer to the question in the “Takatsu ward” category if the information holder is presented with the question in the “Takatsu ward” category.

One method for solving this problem is to post, on other electronic bulletin boards, a notice to the effect that a statement was written on a certain electronic bulletin board in such a manner that the notice is associated with similar statements written on the other electronic bulletin boards, and thereby prompt readers of the similar questions to read the statement concerned.

This method can prompt a person who reads a question written in a high-activity category to also read a similar question written in a low-activity category. However, using this method, there may occur an event that a large number of notices are issued for a single statement. In such a case, the notices may not be able to promote a responder of a question to write answers sufficiently.

For example, an information holder does not have sufficient time to answer all questions corresponding to a large number of notices. Furthermore, if the information holder judges that it is difficult to even find questions to answer, the information holder may entirely refrain from generating answers including questions the information holder can answer.

There is another method in which information holders register, in advance, profile information such as fields or subject matter(s) in which they have knowledge and a notice for requesting an information holder to answer a question written in an electronic bulletin board is directly sent to the information holder by e-mail or the like on the basis of the profile information.

However, this method has a problem that information holders bear a heavy load. That is, to answer questions utilizing this technique, information holders need to not only input profile information in advance but also process notices that they receive irregularly when questions are written. In particular, as for the latter problem associated with load, there may occur an event, depending on the question writing situation, that a large number of notices are sent to one information holder and the information holder is forced to bear such a heavy load that the information holder cannot deal with, irrespective of his or her intention.

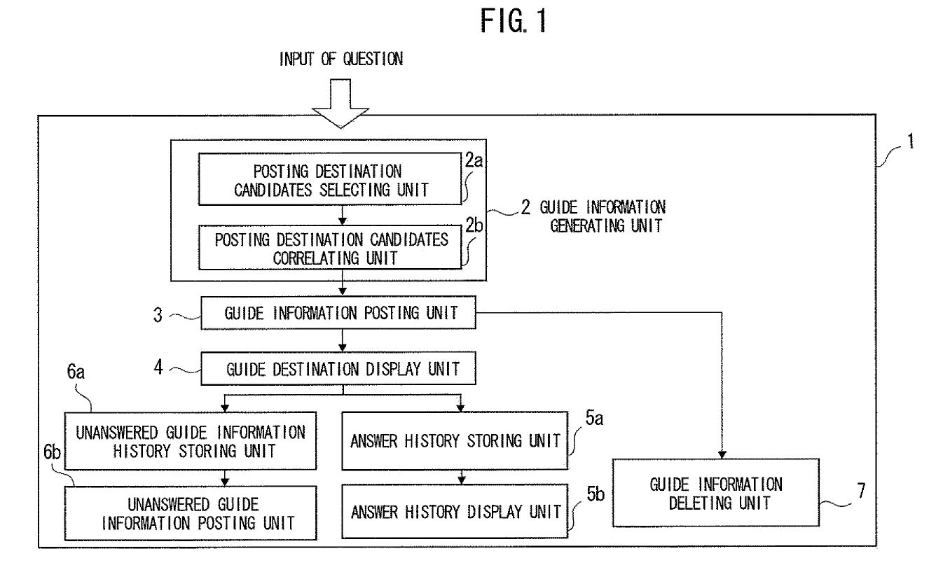

FIG. 1 outlines a configuration of an electronic bulletin board system according to an embodiment. As shown in FIG. 1, the electronic bulletin board apparatus 1 is provided which causes a second user to answer a question of a first user using an answer input picture and is equipped with a guide information generating unit 2, a guide information posting unit 3, and a guide destination display unit 4.

The guide information generating unit 2 generates guide information for guiding the second user to the above-mentioned answer input picture (hereinafter referred to as “guide destination picture”) through which to respond to a first question of the first users on the basis of a second question that is similar to the first question. The guide information posting unit 3 posts the guide information in an answer input picture (hereinafter referred to as “posting destination picture”) through which to respond to the second question. The guide destination display unit 4 displays the guide destination picture on the basis of the guide information selected by the second user among pieces of guide information posted in the posting destination picture.

With the above configuration, in the electronic bulletin board system for realizing a question-answer-type electronic bulletin board service, a question that has been answered only insufficiently is stored as a guide destination. Guide information including information for prompting a user to answer a guide destination that is similar to a question is posted in an answer input picture through which to respond to the question. If the user agrees to be guided according to the guide information, an answer input picture through which to respond to the guide destination can be presented to the user. This makes it possible to increase the probabilities that users who hold necessary information at high probabilities notice the presence of a question and, as a result, increase the probability that a proper answer is written in response to the question.

The electronic bulletin board apparatus 1 is equipped with an answer history storing unit 5a and an answer history display unit 5b. The answer history storing unit 5a stores contents of an answer as answer history information when an answer is input to an answer input picture. The answer history display unit 5b displays the answer history information in an answer input picture that has been displayed on the basis of guide information and is different from the answer input picture in which the answer has been input.

According to this configuration, when a user who answered a question answers a similar question successively being guided by guide information, the user can generate an answer using the contents of a past answer that is posted in a reusable manner. The load of the answerer can thus be reduced.

The electronic bulletin board apparatus 1 is equipped with an unanswered guide information history storing unit 6a and an unanswered guide information posting unit 6b. The unanswered guide information history storing unit 6a stores, as part of an unanswered guide information history, unselected guide information among pieces of guide information posted by the guide information posting unit 3. The unanswered guide information posting unit 6b posts the unselected guide information in the guide destination picture to which guidance has been provided by the selected guide information, on the basis of the unanswered guide information history.

According to this configuration, even if an information holder has been guided to another individual view by guide information, the information holder is allowed to refer to all pieces of guide information that the information holder viewed before the guidance and may cause the information holder to write answers, by virtue of posted unanswered guide information. This allows the information holder to answer all answerable questions without fail.

The guide information generating unit 2 may be composed of a posting destination candidates selecting unit 2a and a posting destination candidates correlating unit 2b. The posting destination candidates selecting unit 2a selects a minimum number of second questions that have high similarity with the first question in such a range that an expected value of the number of answers in a prescribed period becomes greater than or equal to a prescribed value, and employs the selected second questions as posting destination candidates to be posted in posting destination pictures. Alternatively, the posting destination candidates selecting unit 2a may select a minimum number of second questions that have high similarity with the first question in such a range that an expected value of a number of times of reading of the first question in a prescribed period becomes greater than or equal to a prescribed value, and employ the selected second questions as posting destination candidates to be posted in posting destination pictures. The posting destination candidates correlating unit 2b generates pieces of guide information by correlating posting destination candidates with the first question. Although a particular configuration of components is illustrated in FIG. 1, the present invention is not limited to any particular implementation. For example, the posting destination candidate selecting unit 2a and the posting destination candidates correlating unit 2b provided as separate units may be implemented as a single unit, or other components of the electronic bulletin board 1 may be communicatively coupled via a network.

This configuration makes it possible to generate pieces of guide information in a manner that the expected value of the number of answers (alternatively, the number of times of reading of the first question) in the prescribed period is approximately constant. Furthermore, since this configuration can suppress a size of a guide information queue and, as a result, can fairly secure opportunities for writing answer(s) to questions.

The posting destination candidates selecting unit 2a may re-select, as posting destination candidates, a minimum number of second questions that have high similarity with the first question in such a range that a sum of an expected value of the number of answers in a prescribed period and a number of current answers becomes greater than or equal to a prescribed value.

This configuration makes it possible to prevent an event that pieces of guide information for guidance to a question are posted in association with less similar questions while transferring, to other questions, opportunities for writing answer(s) to the question.

The electronic bulletin board apparatus 1 is equipped with a guide information deleting unit 7. The guide information deleting unit 7 deletes pieces of guide information for guidance to the first question if a number of answers to the first question is larger than or equal to a prescribed number.

This configuration makes it possible to reduce the number of posted pieces of guide information to a proper number and thereby reduce the load of answering of each information holder while securing a certain level of opportunities for answerers to be guided to questions.

The electronic bulletin board system according to an embodiment of the invention is described below in detail.

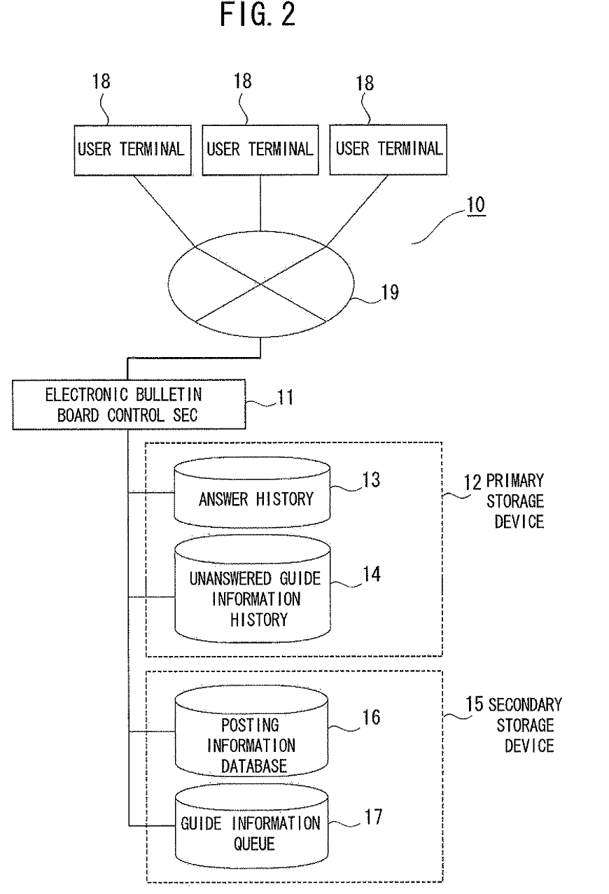

FIG. 2 shows a conceptual configuration of an electronic bulletin board system according to an embodiment. In this embodiment, the electronic bulletin board system 10 has an answerer guiding function. As shown in FIG. 2, the electronic bulletin board system 10 is composed of an electronic bulletin board control section (sec) 11, a primary storage device 12, a secondary storage device 15, user terminals 18, and a network 19. The electronic bulletin board control section 11, the primary storage device 12, and the secondary storage device 15 may be provided in either a single server or plural servers.

The electronic bulletin board control section 11 runs programs for executing processes (described in detail below) according to an embodiment of the invention. The primary storage device 12, which may be a volatile storage device, stores an answer history 13 of a user and unanswered guide information (i.e., guide information for guidance to unanswered questions) history 14. The answer history 13 and the unanswered guide information history 14 may be deleted upon a shutdown of a communication session with the user terminal 18.

The secondary storage device 15, which may be a nonvolatile storage device, is provided with a posting information database 16 and a guide information queue 17. Questions, answers, and accompanying information are stored in the posting information database 16. Pieces of guide information which are described in detail below are registered in the guide information queue 17.

The electronic bulletin board control section 11 receives question information or answer information from a user terminal 18 (e.g., personal computer or cell phone) and supplies answer information or question information to the user terminal 18 over the network 19.

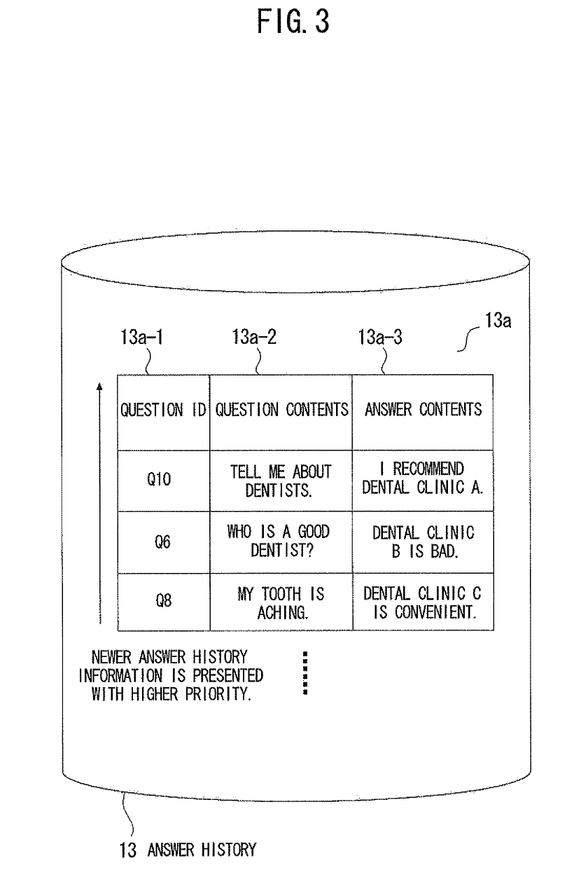

FIG. 3 shows an exemplary data structure of an answer history 13 according to an embodiment. The answer history 13 may be contained in an answer history table 13a which is constructed in a prescribed area of the primary storage device 12. As shown in FIG. 3, the answer history 13 may include a question ID 13a-1, question contents 13a-2, answer contents 13a-3.

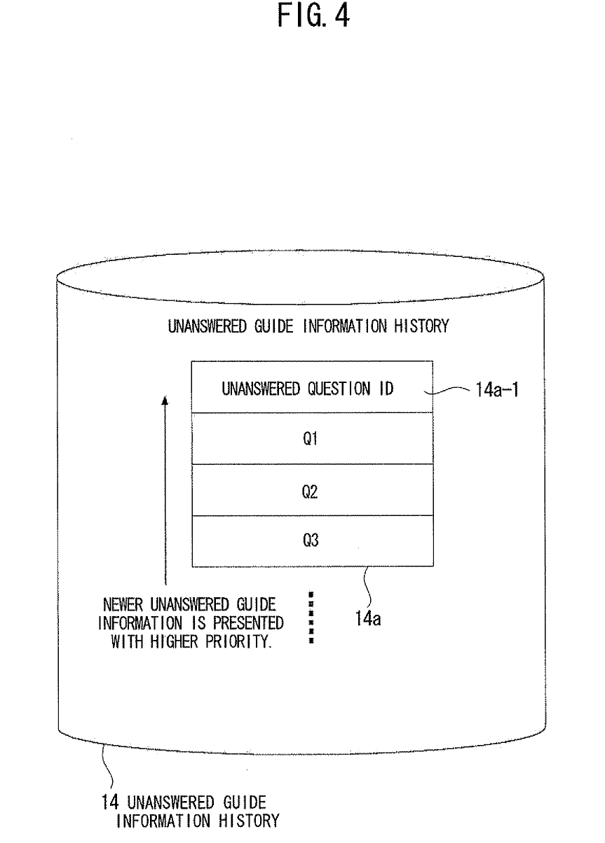

FIG. 4 shows an exemplary data structure of an unanswered guide information history 14 according to an embodiment. The unanswered guide information history 14 is a history of guide information for guidance to unanswered questions. The unanswered guide information history 14 may be contained in an unanswered guide information history table 14a which is constructed in a prescribed area of the primary storage device 12.

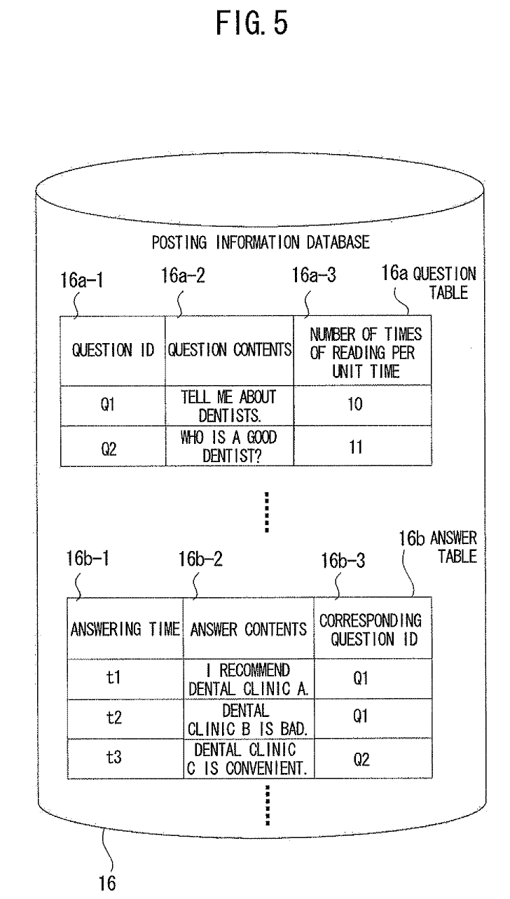

FIG. 5 shows an exemplary data structure of a posting information database 16 according to an embodiment. A question table 16a and an answer table 16b are stored in the posting information database 16. Pieces of information relating to questions from users are contained in the question table 16a. Pieces of information relating to answers to questions are contained in the answer table 16b.

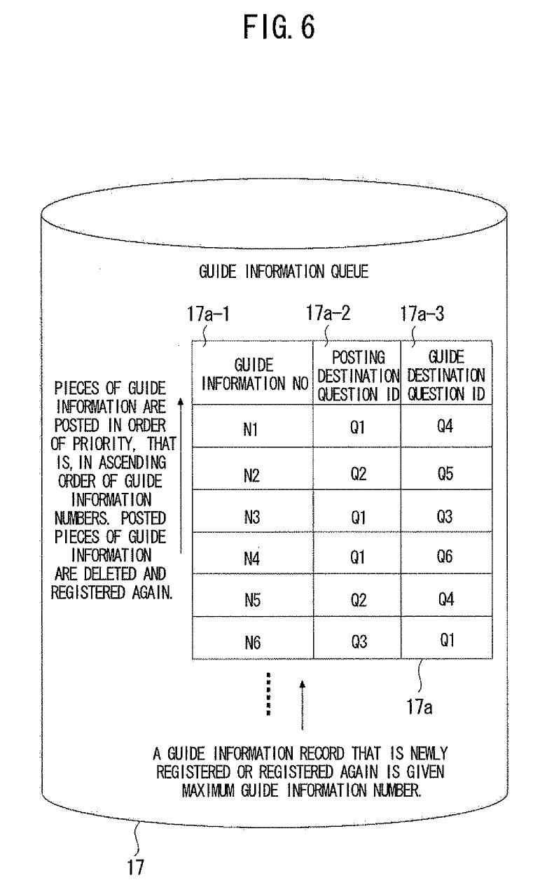

FIG. 6 shows an exemplary data structure of a guide information queue 17 according to an embodiment. Pieces of guide information each having a data structure shown in FIG. 6 (guide information table 17a) are stored in the guide information queue 17.

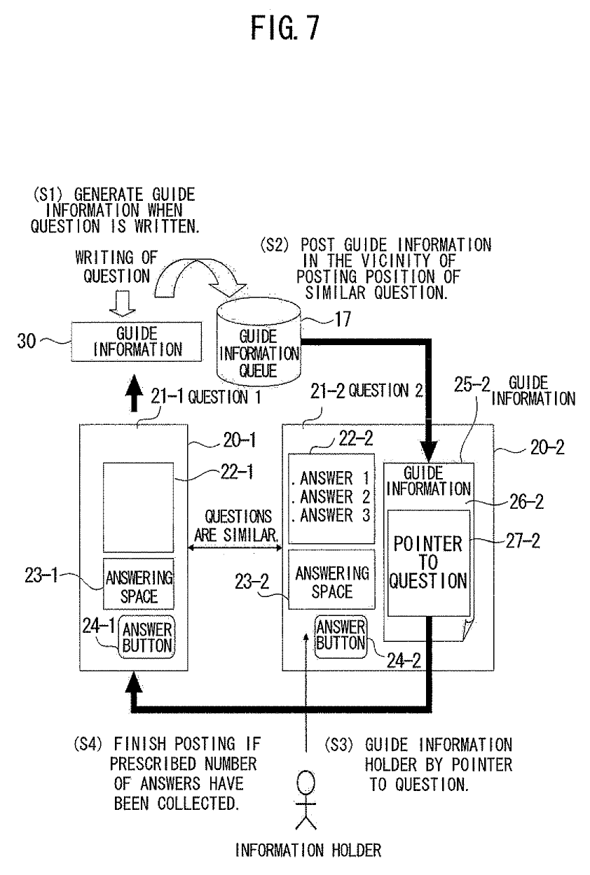

FIG. 7 outlines a process which is executed by the electronic bulletin board control section 11 according to an embodiment. A user accesses the electronic bulletin board system 10 which is constructed with involvement of the network 19, using the user terminal 18. Then, as shown in FIG. 20, a list view 103 of a selected category is displayed on the display device of the user terminal 18. A list 104 of questions in the selected category is displayed in the list view 103.

The user writes a question (e.g., question 1) in the question input form 105 using the user terminal 18. The written question (question 1) is sent to the electronic bulletin board control section 11.

The electronic bulletin board control section 11 registers the received question (question 1) in the posting information database 16 (FIG. 6). Furthermore, the electronic bulletin board control section 11 generates pieces of guide information 25 for guiding answers to the question and registers the guide information in the guide information queue 17 (process S1).

The electronic bulletin board control section 11 selects guide information 25 to be posted from the guide information queue 17 in response to a request for reading of a question (e.g., question 2) as a candidate for a posting destination of guide information 25. Then, the electronic bulletin board control section 11 posts the posting information (i.e., the contents of question 2 and the contents of answers to question 2) acquired from the posting information database 16 in an individual view 20 (i.e., a view for reading a question and answers and writing an answer). Furthermore, the electronic bulletin board control section 11 posts, in the individual view 20, the guide information 25 for guidance to a question that is similar to the posted question (process S2). The guide information 25 includes a pointer (for example, address information) 27 to a question as a guide destination (for example, link destination).

The individual view 20 may be a picture that is displayed for each question and allows input of an answer to the question. As shown in FIG. 7, a list 22 (22-1 or 22-2) of answers to a selected question 21 (21-1 or 21-2) is displayed in the individual view 20 (20-1 or 20-2). The individual view 20 is also provided with an answer input form 23 (23-1 or 23-2) for inputting an answer and an answer button 24 (24-1 or 24-2) for registering the thus-input answer.

If a reader selects the pointer 27 (27-1 or 27-2) to the guide destination included in the guide information 25 (25-1 or 25-2), the electronic bulletin board control section 11 guides the reader to a guide destination individual view 20 (process S3).

The reader writes an answer to the guide destination question in the answer input form 23 and depresses the answer button 24 in the individual view 20. In response, the electronic bulletin board control section 11 checks whether a prescribed number of answers to the question have been collected. If a prescribed number or more of answers have already been collected, the electronic bulletin board control section 11 deletes pieces of guide information 25 for guidance to the question (process S4). The details of each process will be described below.

Guide Information Generation Process (S1)

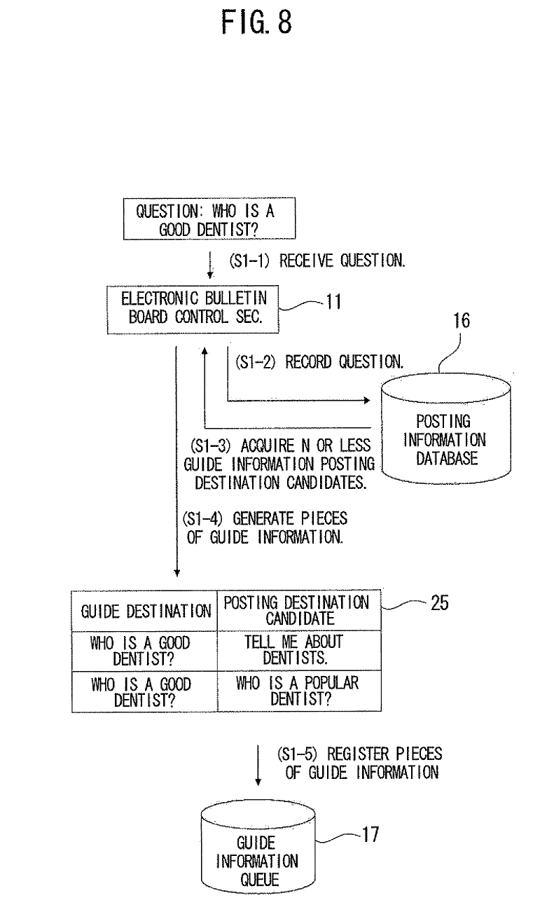

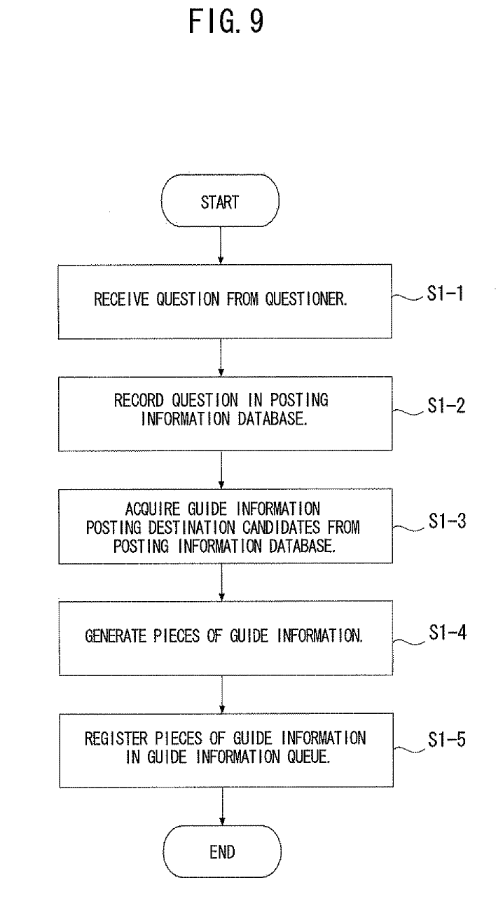

FIG. 8 shows details of a guide information generation process (S1) according to an embodiment. FIG. 9 shows an operation flow of an electronic bulletin board control section 11 which corresponds to the guide information generation process (S1).

As shown in FIGS. 8 and 9, by accessing the electronic bulletin board system 10 using the user terminal 18, a user causes a list view 103 to be displayed and writes a question (e.g., “Who is a good dentist?”) in the question input form 105.

The electronic bulletin board control section 11 receives the question information that has been written on the electronic bulletin board from the user terminal 18 over the network 19 (operation S1-1). The electronic bulletin board control section 11 records the received question information in the posting information database 16 (operation S1-2).

As shown in FIG. 5, each record of the question table 16a includes data items of “question ID” 16a-1, “question contents” 16a-2, and “number of times of reading per unit time” 16a-3. The electronic bulletin board control section 11 stores the received question information as “question contents” 16a-2. At this time, the electronic bulletin board control section 11 generates, for the received question information, an ID (question ID) that is managed uniquely in the electronic bulletin board system 10 and stores the generated question ID as a “question ID” 16a-1. The “number of times of reading per unit time” 16a-3 is a number of times of reading of the question per unit time and is incremented by the electronic bulletin board control section 11 every time the question is read. In the following, a record contained in the question table 16a will be referred to as “question information record.”

The electronic bulletin board control section 11 extracts, as guide information posting destination candidates, N (arbitrary integer) or less question information records whose question contents 16a-2 (e.g., “Tell me about dentists” and “Who is a popular dentist?”) are high in the text similarity with the question contents 16a-2 of the question information record that was recorded at operation S1-2 from the question information records contained in the posting information database 16 (operation S1-3).

Then, the electronic bulletin board control section 11 generates pieces of guide information 25 by correlating the question IDs (posting destination question IDs) of the question information records that have been extracted as the posting destination candidates with the question ID (guide destination question ID) that was used as an extraction key (operation S1-4).

Then, the electronic bulletin board control section 11 registers the pieces of guide information 25 in the guide information table 17a of the guide information queue 17 (operation S1-5). Each record of the guide information table 17a includes data items of “guide information number” 17a-1, “posting destination question ID” 17a-2, and “guide destination question ID” 17a-3.

The “guide information number” 17a-1 is a number to be used for uniquely managing the associated record in the guide information table 17a. A maximum guide information number is given by the electronic bulletin board control section 11 when a guide information record is newly registered or registered again. As described later, pieces of guide information 25 may be posted in order of priority, that is, in ascending order of guide information numbers. As described later, posted pieces of guide information 25 are deleted from the guide information table 17a and registered again at the tail of the guide information table 17a.

The question ID of the posting destination of each piece of guide information 25 is contained as a “posting destination question ID” 17a-2. The question ID of the guide destination (for example, link destination) of each piece of guide information 25 is contained as a “guide destination question ID” 17a-3.

Guide information 25 for guidance to a question may be posted in displaying an answer input picture of one of posting destination candidates by selecting, as posting destination candidates, at operation S1-3, when the question has been written, questions that have high similarity with the written question so that as small a number as possible of questions are selected in such a range that the expected value of the number of times of posting of the written question in a prescribed period becomes larger than or equal to a prescribed value. Alternatively, guide information 25 for guidance to a question may be posted in displaying an answer input picture of one of posting destination candidates by selecting, as posting destination candidates, at operation S1-3, when the question has been written, questions that have high similarity with the written question so that as small a number as possible of questions are selected in such a range that the expected value of the number of answers in a prescribed period becomes larger than or equal to a prescribed value.

In the former case (the expected value of the number of times of posting in the prescribed period is used), the following procedure is followed. Questions that are similar to written question are extracted in descending order of similarity. Expected values of a numbers of times of posting of pieces of guide information 25 for guidance to a written question in the prescribed period are calculated on the basis of result values of a numbers of times of reference of the similar questions, respectively, and a minimum number of similar questions are selected as posting destination candidates in such a range that pieces of guide information 25 are expected to be posted in the prescribed number or more. Pieces of guide information 25 each including the written question and a posting destination candidate are generated for the respective selected posting destination candidates.

This configuration makes it possible to generate pieces of guide information 25 in a manner that the expected value of the number of times of posting in the prescribed period is approximately constant. Furthermore, since this configuration can suppress the size of the guide information queue 17 and, as a result, can fairly secure opportunities for answerers to be guided to questions.

On the other hand, in the latter case (the expected value of the number of answers in the prescribed period is used), the following procedure is followed. Questions QA that are similar to a question just received (written question QR) are extracted in descending order of similarity. Expected values of a numbers of times of writing of answers to the written question QR in the prescribed period are calculated on the basis of result values of the numbers of times of reference of the extracted similar questions QA and their answer writing probabilities estimated on the basis of their similarities with the written question QR, respectively, and a minimum number of similar questions are selected as posting destination candidates in such a range that answers are expected to be written in the prescribed number (hereinafter referred to as “number-of-answers reference value”) or more. Pieces of guide information 25 each including the written question and a posting destination candidate are generated for the respective selected posting destination candidates.

This configuration makes it possible to generate pieces of guide information 25 in a manner that the expected value of the number of answers in the prescribed period is approximately constant. Furthermore, since this configuration can suppress the size of the guide information queue 17 and, as a result, can fairly secure opportunities for writing answers to questions.

Operation S1-3 for acquiring guide information posting destination candidates will be described below in detail for the case that the expected values of the numbers of answers are used.

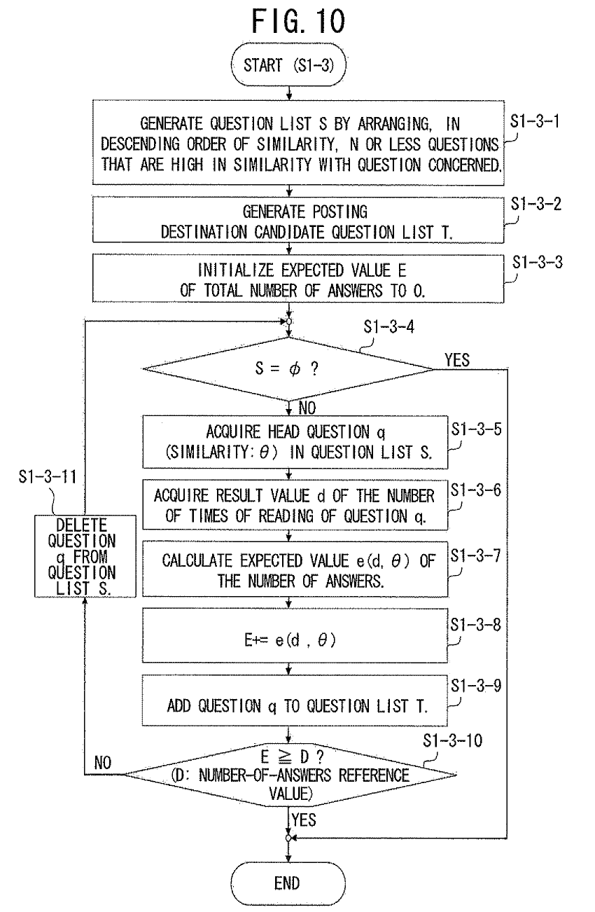

FIG. 10 shows a detailed flow of operation S1-3 for acquiring guide information posting destination candidates. The electronic bulletin board control section 11 extracts N or less question information records RA each having question contents QA that have high similarity with the question contents QR of a question information record RR concerned from the question information records recorded in the question table 16a of the posting information database 16. For example, similarity can be determined on the basis of text similarity, presence/absence of keywords that are set by a user, or a frequency of occurrence of such keywords.

Then, the electronic bulletin board control section 11 generates a question list S in which the extracted question information records RA are arranged in descending order of similarity (operation S1-3-1).

Then, the electronic bulletin board control section 11 generates a question list T of posting destination candidates (posting destination candidate question list) (operation S1-3-2). In an initial state, the question list T is φ (empty set). Then, the electronic bulletin board control section 11 initializes the expected value E of the total number of answers in a prescribed period to 0 (operation S1-3-3).

Subsequently, the electronic bulletin board control section 11 checks whether the question list S is φ (operation S1-3-4). If the question list S is not φ (operation S1-3-4: no), the flow moves to operation S1-3-5. If the question list S is φ (operation S1-3-4: yes), the electronic bulletin board control section 11 finishes this flow.

If it is judged at operation S1-3-4 that the question list S is not φ (operation S1-3-4: no), the electronic bulletin board control section 11 acquires the head question q in the question list S (operation S1-3-5). The similarity of the question q is represented by θ.

The electronic bulletin board control section 11 acquires, as a result value d, the number of times of reading of the question q in a past prescribed period (operation S1-3-6). That is, the electronic bulletin board control section 11 employs, as the result value d, the value of the “number of times of reading per unit time” 16a-3 of the question information record of the question q.

Then, the electronic bulletin board control section 11 calculates an expected value e(d, θ) of the number of times of answering through guidance from the question q on the basis of the result value d and the similarity θ (operation S1-3-7). For example, an expected value e(d, θ) of the number of answers may be calculated according to e(d, θ)=v(d)×r(θ) where v(d) is the expected value of the number of times of reading in an immediately following prescribed period that is estimated on the basis of the number of times of reading in an immediately preceding prescribed period and r(θ) is the approximate value of the probability of answering per reading that is set so as to be larger when the similarity θ is higher.

Then, the electronic bulletin board control section 11 adds the expected value e(d, θ) of the number of answers to the expected value E of the total number of answers (operation S1-3-8), and adds the question q to the posting destination candidate question list T (operation S1-3-9).

Then, the electronic bulletin board control section 11 compares the expected value E of the total number of answers with the number-of-answers reference value D (operation 51-3-10). If the expected value E of the total number of answers is smaller than the number-of-answers reference value D (S1-3-10: no), the electronic bulletin board control section 11 deletes the question q from the question list S (operation S1-3-11). The flow returns to operation S1-3-4.

If the expected value E of the total number of answers is larger than or equal to the number-of-answers reference value D (S1-3-10: yes), the electronic bulletin board control section 11 finishes this flow.

The above-described operation S1-3 makes it possible to select guide information posting destination candidates in a manner that the expected value of the number of answers in the prescribed period is approximately constant. Furthermore, since this operation S1-3 can suppress the size of the guide information queue 17 and, as a result, can fairly secure opportunities for writing of answers to questions.

Guide Information Posting Process (S2)

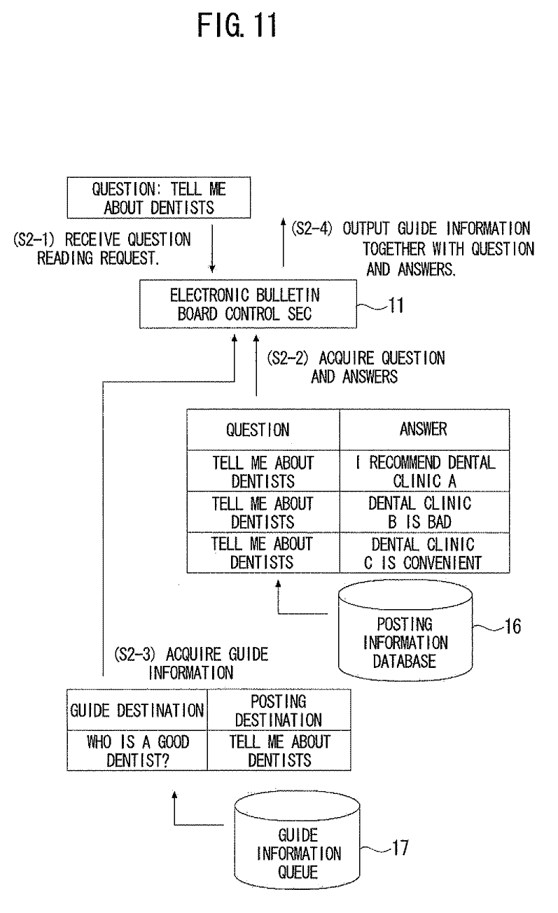

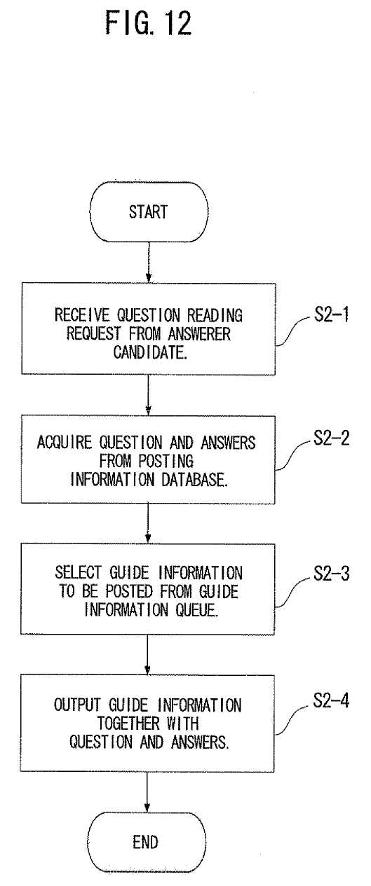

FIG. 11 shows details of the guide information posting process (S2) according to an embodiment. FIG. 12 shows an operation flow of the electronic bulletin board control section 11 which corresponds to the guide information posting process (S2).

First, by accessing the electronic bulletin board system 10 using the user terminal 18, a user selects one of the questions displayed in a list view 103 (e.g., “Tell me about dentists”) and thereby causes an individual view 20 to be displayed. As a result, a request (including the question ID of the question) for reading of the question (“Tell me about dentists”) is sent to the electronic bulletin board control section 11.

The electronic bulletin board control section 11 receives the request for reading of the question (“Tell me about dentists”) over the network 19 (operation S2-1).

The electronic bulletin board control section 11 acquires the reading-requested question and corresponding answers (e.g., “I recommend dental clinic A” and “Dental clinic B is bad”) from the question table 16a and the answer table 16b of the posting information database 16 using the question ID of the reading-requested question as a key (operation S2-2). As shown in FIG. 5, each record of the question table 16b includes data items of “answering time” 16b-1, “answer contents” 16b-2, and “corresponding question ID” 16b-3. A time when answer information was registered by depression of an answer button 24 is contained as an “answering time” 16b-1. The contents of the answer that was written on the bulletin board by an information holder is contained as “answer contents” 16b-2. The question ID corresponding to the “answer contents” 16b-2 is contained as a “corresponding question ID” 16b-3.

Then, the electronic bulletin board control section 11 acquires guide information 25 to be posted (or output) in the individual view 20 from the guide information queue 17 (operation S2-3). More specifically, the electronic bulletin board control section 11 searches the “posting destination question IDs” 17a-2 of the guide information table 17a and thereby extracts guide information records whose “posting destination question IDs” 17a-2 are the same as the question ID included in the request for reading of the question concerned. Furthermore, the electronic bulletin board control section 11 acquires, from the question table 16a, the contents of questions (guide destination question contents 16a-2) corresponding to question IDs 16a-1 that are the same as the “guide destination question IDs” 17a-3 of the extracted guide information records, respectively.

Then, the electronic bulletin board control section 11 posts, on the individual view 20, the reading-requested question (“Tell me about dentists”), the corresponding answers (“I recommend dental clinic A” and “Dental clinic B is bad”), and the guide information 25 (guide destination question contents and pointers to guide destinations) (operation S2-4). The electronic bulletin board control section 11 posts the pieces of guide information 25 in priority order, that is, in ascending order of guide information numbers 17a-1. The posted pieces of guide information 25 are deleted from the guide information table 17a and registered again at the tail of the guide information table 17a.

The above-described process S2 makes it possible to increase probabilities that users who hold necessary information at high probabilities notice a presence of a question and hence increase the probability that proper answers are written.

Process for Guiding Information Holder to Question with Small Number of Answers (S3)

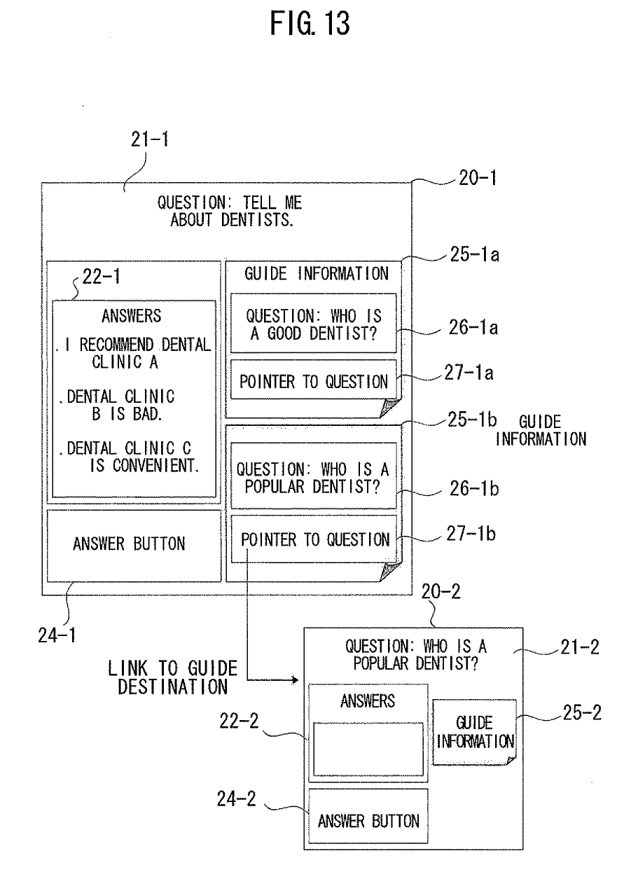

FIG. 13 shows the details of the process (S3) for guiding an information holder to a prescribed question according to an embodiment. FIG. 13 shows an exemplary individual view 20-1 in which a question 21-1 (“Tell me about dentists”), corresponding answers 22-1 (“I recommend dental clinic A,” “Dental clinic B is bad,” and “Dental clinic C is convenient”), and pieces of guide information 25-1a and 25-1b are posted.

The pieces of guide information 25-1a and 25-1b include pointers 27-1a and 27-1b to similar guide destination questions (“Who is a good dentist” 26-1a and “Who is a popular dentist” 26-1b), respectively, in a selectable manner. If a user selects the pointer 27-1b, for example, which is included in the guide information 25-1b, an individual view 20-2 of the guide destination question is presented to the reader (i.e., displayed on the display device of the user terminal 18).

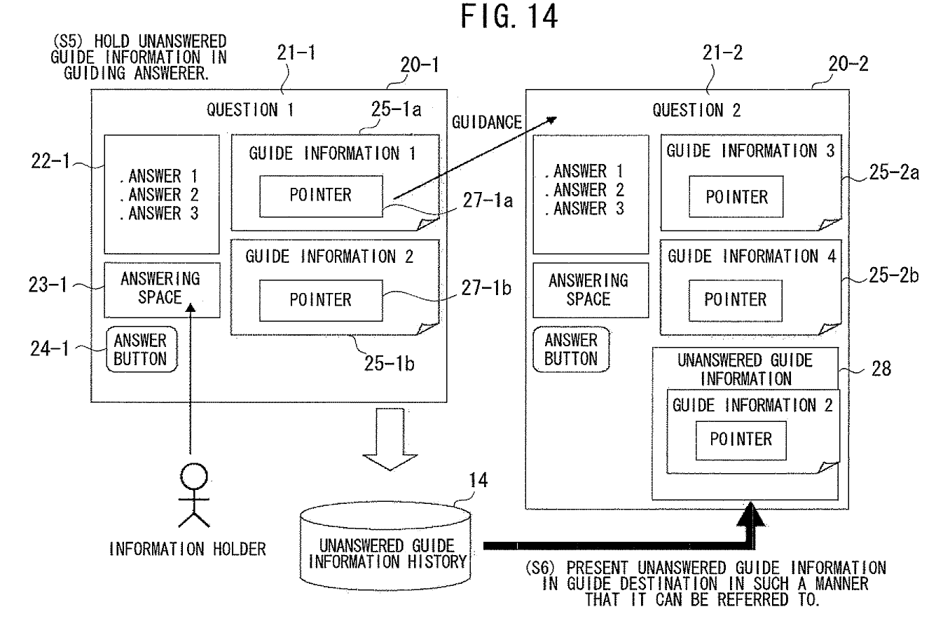

In this embodiment, a procedure shown in FIG. 14 may further be employed in which guide information 25-1a that is posted in the picture 20-1 presented to the user and corresponds to the question 26-1a that has not been answered by the user is stored as part of an unanswered guide information history 14 of the user. The unanswered guide information history 14 of the user is posted in an answer input picture when the user writes an answer to another question after being guided by the guide information 25-1b.

FIG. 14 shows a process for displaying unanswered guide information in a guide destination picture according to an embodiment. Assume that a reader of an individual view 20-1 in which a question (question 1) is posted selects a pointer 26-1a to a guide destination that is included in guide information 1 (25-1a). In response, a request for display of an individual view 20-2 of a guide destination question (question 2) is sent to the electronic bulletin board control section 11.

The electronic bulletin board control section 11 stores, as part of the unanswered guide information history 14, guide information 2 (25-1b) for guidance to an unanswered question that was not selected (process S5). As shown in FIG. 4, each record of the unanswered guide information history table 14a is a data item “unanswered question ID” 14a-1. The “question ID” of an unanswered question is contained as an “unanswered question ID” 14a-1. The electronic bulletin board control section 11 stores, as an “unanswered question ID” 14a-1, the guide destination question ID of the guide information 2 (25-1b) for guidance to the unanswered question.

Then, the electronic bulletin board control section 11 displays, in the individual view 20-2 of the guide destination question 2, guide information 3 (25-2a) and guide information 4 (25-2b) that correspond to question 2.

Furthermore, the electronic bulletin board control section 11 displays the guide information 2 for guidance to the unanswered question in the transition source individual view 20-1, in the transition destination individual view 20-2 as unanswered guide information 28 (i.e., guide information that was posted in the past but has not been answered yet) (process S6). That is, the electronic bulletin board control section 11 displays the guide information (guide destination question contents and a pointer to a guide destination) corresponding to the “unanswered question ID” 14a-1 in the unanswered guide information history table 14a, in the transition destination individual view 20-2 as the unanswered guide information 28. The electronic bulletin board control section 11 operates so that a newer piece of unanswered guide information is presented with higher priority. If the user answers being guided by the unanswered guide information 28, the unanswered guide information 28 is deleted from the unanswered guide information history table 14a.

As a result of the execution of the above processes, even after an information holder has been guided to another individual view 20 by guide information 25, the information holder is allowed to refer to all pieces of guide information 25 that the information holder viewed before the guidance and may cause the information holder to write answers, by virtue of unanswered guide information 28 that is posted by the process S6. This makes it easier for the information holder to answer all answerable questions without fail.

Guide Information Posting Finishing Process (S4)

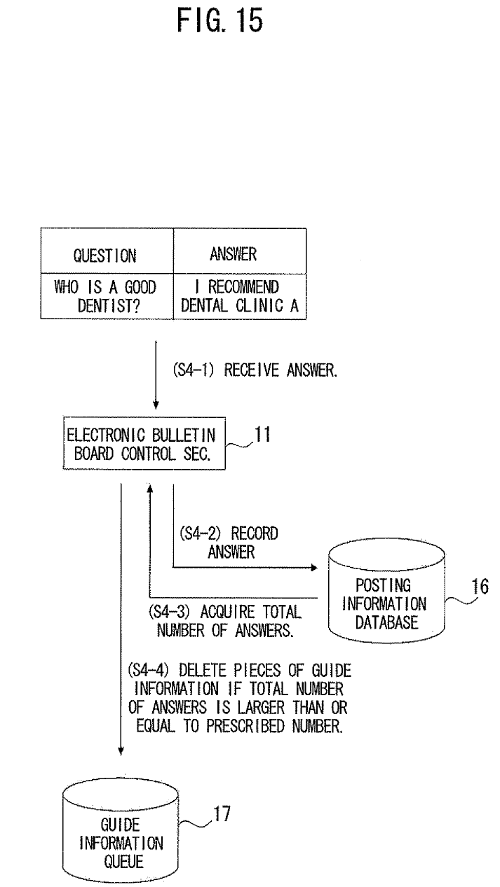

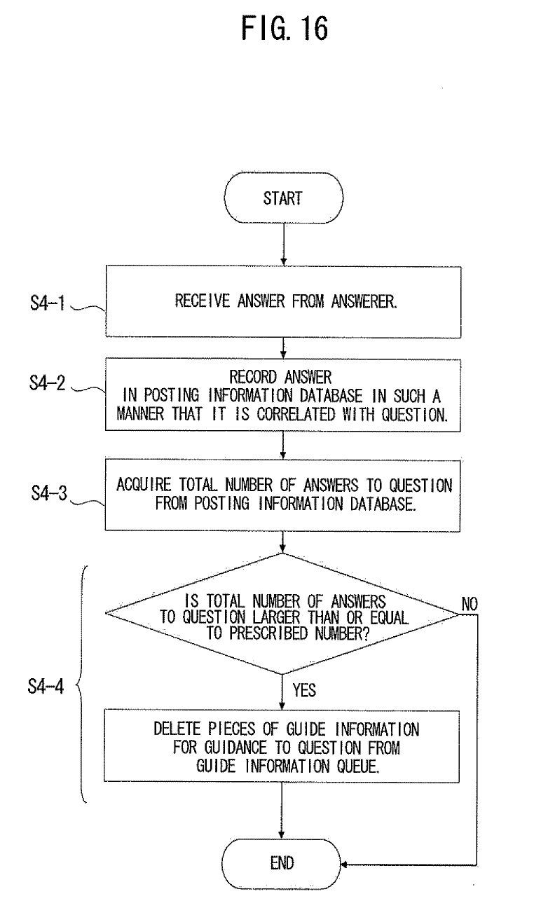

FIG. 15 shows the details of the guide information posting finishing process (S4) according to an embodiment. FIG. 16 shows an operation flow of the electronic bulletin board control section 11 which corresponds to the guide information posting finishing process (S4).

First, the electronic bulletin board control section 11 receives answer information that has been written on the electronic bulletin board (operation S4-1). Then, the electronic bulletin board control section 11 records the received answer information in the answer table 16b of the posting information database 16 (operation S4-2). More specifically, the electronic bulletin board control section 11 stores an answering time, the contents of the answer, and a question ID corresponding to the answer of the received answer information in the answer table 16b as an “answering time” 16b-1, “answer contents” 16b-2, and a “corresponding question ID” 16b-3, respectively.

Then, the electronic bulletin board control section 11 acquires the total number of answers to the question concerned from the posting information database 16 (operation S4-3). More specifically, the electronic bulletin board control section 11 extracts “corresponding question IDs” 16b-3 that are the same as the question ID corresponding to the answer of the received answer information from the answer table 16b, and counts the extracted records to obtain a total number of answers.

If the total number of answers is larger than or equal to a prescribed number, the electronic bulletin board control section 11 deletes pieces of guide information 25 for guidance to the question concerned from the guide information queue 17 (operation S4-4). More specifically, the electronic bulletin board control section 11 searches for “guide destination question IDs” 17-3 in the guide information table 17a that are the same as the question ID of the question concerned, and deletes them.

As described above, in the guide information posting finishing process (S4), pieces of guide information 25 for guidance to a question for which a prescribed number or more of answers have been collected are deleted from the guide information queue 17, whereby posting of pieces of guide information 25 that are unnecessary in terms of collection of answers is suppressed. This makes it possible to reduce the number of posted pieces of guide information 25 to a proper number and thereby reduce the load of answering of each information holder while securing a certain level of opportunities for answerers to be guided to questions.

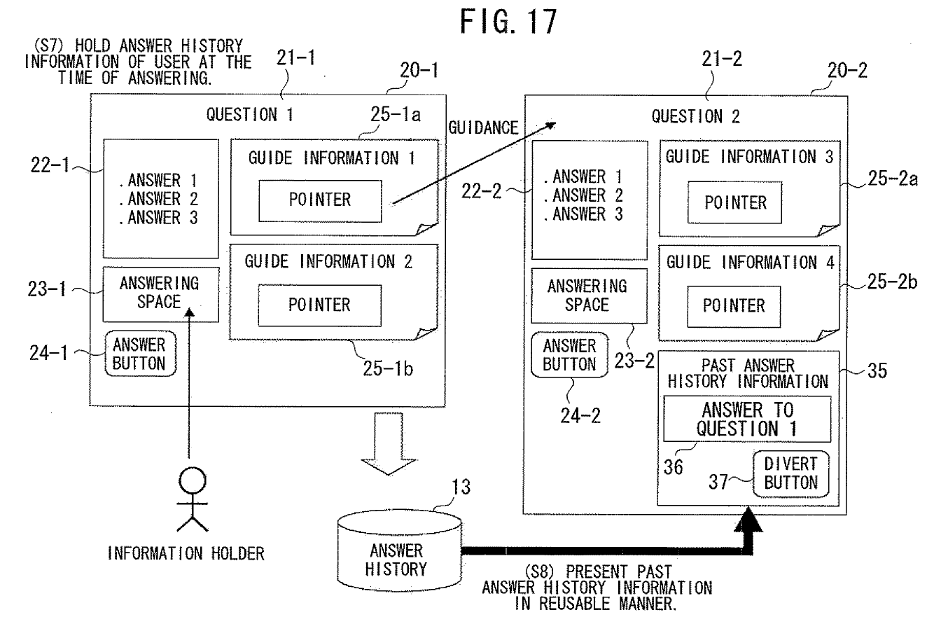

In this embodiment, a procedure shown in FIG. 17 may further be employed in which when a user has written an answer the contents of the answer are stored as part of an answer history of the user (answer histories are provided for respective users) and in which the answer history of the user is posted in an answer input picture when the user writes an answer to another question.

FIG. 17 illustrates a process for displaying a past answer history in a reusable form according to an embodiment. When an information holder writes an answer to question 1 in an answering space 23-1 and depresses an answer button 24-1, the answer information is sent to the electronic bulletin board control section 11. The electronic bulletin board control section 11 stores the received answer information in the answer history table 13a (see FIG. 3) as part of an answer history 13 (process S7).

Each answer history record of the answer history table 13a includes data items of “question ID” 13a-1, “question contents” 13a-2, and “answer contents” 13a-3. Answer history records are registered in descending order of writing of answers so that newer answer history information is presented with higher priority to the user terminal 18.

Then, an answer history of the user is posted in an individual view 20-2 together with pieces of guide information 25-2a and 25-2b (posted by the process S2) in such a manner that the contents of the answers can be reused (process S8). More specifically, assume that the information holder has selected the pointer of guide information 1 (25-1a) after answering question 1 as described above and a transition has been made to the individual view 20-2 of question 2. The individual view 20-2 of question 2 is provided with a display portion 35 for display of a past answer history in addition to an answer list 22-2, an answering space 23-2, an answer button 24-2, guide information 3 (25-2a), and guide information 4 (25-2b). The display portion 35 has a space 36 for display of a past answer history and a divert button 37.

To display the individual view 20-2 of question 2, the electronic bulletin board control section 11 acquires the last-registered answer history record from the answer history records contained in the answer history table 13a and displays its “answer contents” 13a-3 in the display space 36. In this example, the contents of the answer that was written in the individual view 20-1 of question 1 are displayed.

If the user depresses the divert button 37, the electronic bulletin board control section 11 copies the answer being displayed in the display space 36 into the answering space 23-2.

Where the processes S7 and S8 are executed, when a user who answered a question answers a similar question successively being guided by guide information 25, the user can generate an answer using the contents of a past answer that is posted in a reusable manner by the process S8. The load of the answerer can thus be reduced.

In this embodiment, when an answer to a question is written, questions that have high similarity with the question concerned may be re-selected as posting destination candidates in such a manner that the number of such similar questions is as small as possible in such a range that the sum of the expected value of the number of answers in a prescribed period and the number of current answers becomes greater than or equal to a prescribed value. That is, if the number of collected answers is smaller than the prescribed number in the process S4, pieces of guide information 25 may be reconstructed according to the procedure of FIG. 10 after subtracting the number of current answers from the above-mentioned number-of-answers reference value.

This procedure makes it possible to prevent an event that pieces of guide information 25 for guidance to a question are posted in association with less similar questions while transferring, to other questions, opportunities for writing of answers to the question.

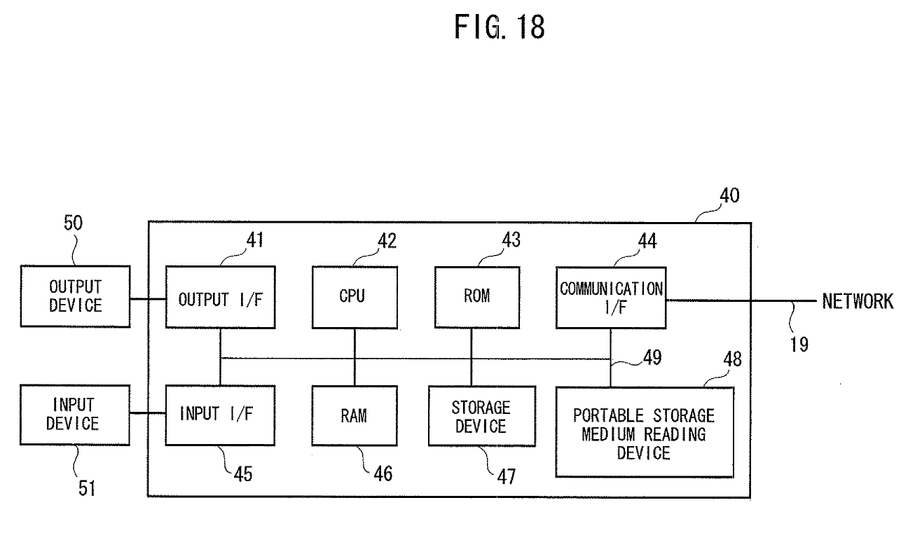

FIG. 18 is a block diagram showing the hardware configuration of a server as an exemplary implementation of an electronic bulletin board control system according to an embodiment. As shown in FIG. 18, the server 40 is composed of a CPU 42, a read-only memory (ROM) 43, a random access memory (RAM) 46, a communication interface 44 (in the following, the term “interface” will be abbreviated as I/F), a large-capacity storage device 47, an output I/F 41, an input I/F 45, a portable storage medium reading device 48, and a bus 49 to which all of the above devices are connected. An output device 50 and an input device 51 are connected to the output I/F 41 and the input I/F 45, respectively.

In this embodiment, the CPU 42 corresponds to the electronic bulletin board control section 11. The large-capacity storage device 47 may be any of various types of storage devices (media) such as a hard disk, a magnetic disk, and a flash memory. Programs for the flows according to an embodiment are stored in the storage device 47 or the ROM 43. In an embodiment, the RAM 46 and the large-capacity storage device 47 correspond to the primary storage device 12 and the secondary storage device 15, respectively.

The programs used in an embodiment may be sent from a program supplier side via the network 19 and the communication I/F 44 and stored in the large-capacity storage device 47, for example. Alternatively, the programs may be stored in a portable storage medium on the market and executed by the CPU 42 in a state that the portable storage medium is set in the reading device 48. The portable storage medium may be any of various types of storage media such as a CD-ROM, a flexible disk, an optical disc, a magneto-optical disc, and an IC card. The programs stored in such a storage medium are read by the reading device 48.

The input device(s) 51 may be a keyboard and a mouse or a digital camera, a microphone, a scanner, a sensor, a tablet, or the like. The output device 50 may be a display device, a printer, a speaker, or the like. The network 19 may be a communication network such as the Internet, a LAN, a WAN, a dedicated line, a wired line, a wireless line, or a public line.

The invention is not limited to the above-described embodiment and other various configurations and forms may be employed without departing from the spirit and scope of the invention.

In an embodiment, the electronic bulletin board with the answerer guiding function is equipped with the electronic bulletin board control section 11, the posting information database 16 in which to record questions, answers, and accompanying information, and the guide information queue 17 for in which to register guide information among the components shown in FIG. 2.

The electronic bulletin board control section 11 mainly executes the following four processes shown in FIG. 7.

(S1) When a question (question 1) is written on the electronic bulletin board, the electronic bulletin board control section 11 registers the question in the posting information database 16. Furthermore, the control section 11 generates pieces of guide information 25 for guiding answerers to the question and registers the generated pieces of guide information 25 in the guide information queue 17.

(S2) in response to a request for reading of a question (question 2) as a guide information posting destination, the control section 11 selects guide information 25 to be posted from the guide information queue 17 and posts the selected guide information 25 in an individual view 20-2 (i.e., a view for reading of a question and answers and writing of an answer) together with posting information (the contents of question 2 and the contents of answers to question 2) that is acquired from the posting information database 16. The guide information 25 includes a pointer to a guide destination question.

(S3) If the reader selects the pointer to the guide destination that is included in the guide information 25, the control section 11 presents, to the reader, an individual view 20-1 in which the guide destination question is posted.

(S4) if the reader writes an answer in the individual view 20-1, the control section 11 checks whether a prescribed number of answers to the question have already been collected. If a prescribed number or more of answers have been collected, the control section 11 deletes the pieces of guide information 25 for guidance to the question.

According to the above configuration, the process S2 makes it possible to present guide information 25 for guidance to a similar question (question 1) to a user who is interested in a certain question (question 2). This makes it possible to increase the probability that users who hold necessary information at high probabilities notice the presence of question 1 and, as a result, increase the probability that proper answers are written. Since pieces of guide information 25 for guidance to a question for which a prescribed number of answers have been collected are deleted from the guide information queue 17 by the process S4, posting of pieces of guide information 25 that are not necessary for collection of answers is prevented. This makes it possible to reduce the number of posted pieces of guide information 25 to a proper number and thereby reduce the load of answering of each information holder while securing a certain level of opportunities for answerers to be guided to questions.

In an embodiment, the electronic bulletin board with the answerer guiding function is also equipped with the component for holding an unanswered guide information history 14 (i.e., pieces of guide information 25 for guidance to unanswered questions that were posted in the past). The electronic bulletin board control section 11 executes the following two processes shown in FIG. 14.

(S5) A reader of an individual view 20-1 in which a question (question 1) is posted instructs the electronic bulletin board control section 11 to display an individual view 20-2 of another question (question 2) using a pointer 27-l a to a guide destination that is included in guide information 25-1a (guide information 1), the control section 11 stores guide information 25-1b (guide information 2) for guidance to an unanswered question in the primary storage device 12 in addition to executing the above-described process S3.

(S6) The control section 11 posts the stored guide information 25-1b (guide information 2) as unanswered guide information in the individual view 20-2 of the guide destination question (question 2) together with information that is posted by the above-described process. S2.

According to this configuration, even after an information holder has been guided to another individual view 20 by guide information 25, the information holder is allowed to refer to all pieces of guide information 25 that the information holder viewed before the guidance and may cause him or her to write answers, by virtue of unanswered guide information that is posted by the process S6. This allows the information holder to answer all answerable questions without fail.

In an embodiment, the electronic bulletin board with the answerer guiding function is also equipped with the component for holding an answer history 13. The electronic bulletin board control section 11 executes the following two processes shown in FIG. 17.

(S7) When a user writes an answer, the control section 11 stores the contents of the answer as part of an answer history 13 in addition to executing the above-described process S4.

(S5) The control section 11 posts the answer history information of the user in an individual view 20 together with information that is posted by the above-described process S2 in such a manner that the contents of the answer are reusable.

According to this configuration, when a user who answered a question answers a similar question successively being guided by guide information 25, the user can generate an answer using the contents of a past answer that is posted in a reusable manner by the process S8. The load of the answerer can thus be reduced.

In an embodiment, the electronic bulletin board with the answerer guiding function may generate pieces of guide information for guidance to a written question according to the following procedure in the process S1. Questions that are similar to the written question are extracted in descending order of similarity. Expected values of the numbers of times of posting of pieces of guide information for the written question in a prescribed period are calculated on the basis of result values of the numbers of times of reference of the similar questions, respectively, and a minimum number of similar questions are selected as posting destination candidates in such a range that pieces of guide information are expected to be posted in a prescribed number or more. Pieces of guide information each including the written question and a posting destination candidate are generated for the respective selected posting destination candidates.

This configuration makes it possible to generate pieces of guide information in a manner that the expected value of the number of times of posting in the prescribed period is approximately constant. Furthermore, since this configuration can suppress the size of the guide information queue 17 and, as a result, can fairly secure opportunities for answerers to be guided to questions.

Alternatively, according to an embodiment, the electronic bulletin board with the answerer guiding function may generate pieces of guide information for guidance to a written question according to the following procedure in the process S1. Questions that are similar to the written question are extracted in descending order of similarity. Expected values of the numbers of times of writing of answers to the written question in a prescribed period are calculated on the basis of result values of the numbers of times of reference of the extracted similar questions and their answer writing probabilities estimated on the basis of their similarities with the written question, respectively, and a minimum number of similar questions are selected as posting destination candidates in such a range that answers are expected to be written in a prescribed number (number-of-answers reference value) or more. Pieces of guide information each including the written question and a posting destination candidate are generated for the respective selected posting destination candidates.

This configuration makes it possible to generate pieces of guide information in a manner that the expected value of the number of answers in the prescribed period is approximately constant. Furthermore, since this configuration can suppress the size of the guide information queue 17 and, as a result, can fairly secure opportunities for writing of answers to questions.

In an embodiment, if the number of collected answers is smaller than the prescribed number in the process S4, the electronic bulletin board with the answerer guiding function can reconstruct pieces of guide information according to the above-discussed operations of extracting questions that are similar to the written question, calculating expected values and generating pieces of guide information after subtracting the number of current answers from the above-mentioned number-of-answers reference value.

This configuration makes it possible to prevent an event that pieces of guide information for guidance to a question are posted in association with less similar questions while transferring, to other questions, opportunities for writing of answers to the question.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An electronic bulletin board apparatus which causes a second user to answer a question of a first user using an answer input picture, comprising:
a guide information generating unit generating guide information for guiding the second user to an answer input picture as a guide destination picture through which to respond to a first question of the first user, based on a second question that is similar to the first question;
a guide information posting unit posting the guide information in an answer input picture as a posting destination picture through which to respond to the second question; and
a guide destination display unit displaying the guide destination picture based on the guide information selected by the second user among pieces of guide information posted in the posting destination picture.

2. The electronic bulletin board apparatus according to claim 1, comprising:
an answer history storing unit storing contents of an answer as answer history information when the answer is input to an answer input picture; and
an answer history display unit displaying the answer history information in an answer input picture that has been displayed based on guide information and is different from the answer input picture in which the answer has been input.

3. The electronic bulletin board apparatus according to claim 1, comprising:
an unanswered guide information history storing unit storing, as part of an unanswered guide information history, unselected guide information among the pieces of guide information posted by the guide information posting unit; and
an unanswered guide information posting unit posting the unselected guide information in the guide destination picture to which guidance has been made by the selected guide information, based on the unanswered guide information history.

4. The electronic bulletin board apparatus according to claim 1, wherein the guide information generating unit comprises:
a posting destination candidates selecting unit selecting a minimum number of second questions having high similarity with the first question within a range that an expected value of a number of times of reading of the first question in a prescribed period becomes greater than or equal to a prescribed value, and employing the selected second questions as posting destination candidates to be posted in posting destination pictures; and
a posting destination candidates correlating unit generating pieces of guide information by correlating the posting destination candidates with the first question.

5. The electronic bulletin board apparatus according to claim 1, wherein the guide information generating unit comprises:
a posting destination candidates selecting unit selecting a minimum number of second questions having high similarity with the first question within a range that an expected value of a number of answers in a prescribed period becomes greater than or equal to a prescribed value, and employing the selected second questions as posting destination candidates to be posted in posting destination pictures; and
a posting destination candidates correlating unit generating pieces of guide information by correlating the posting destination candidates with the first question.

6. The electronic bulletin board apparatus according to claim 5, wherein the posting destination candidates selecting unit re-selects, as posting destination candidates, a minimum number of second questions having high similarity with the first question within a range that a sum of an expected value of the number of answers in a prescribed period and a number of current answers becomes greater than or equal to a prescribed value.

7. The electronic bulletin board apparatus according to claim 1, comprising:
a guide information deleting unit deleting pieces of guide information for guidance to the first question if the number of answers to the first question is larger than or equal to a prescribed number.

8. A computer-readable storage medium having an electronic bulletin board control program is stored to cause a computer to execute operations, comprising:
generating guide information for guiding a second user to an answer input picture as a guide destination picture through which to respond to a first question of a first user, based on a second question that is similar to the first question;
posting the guide information in an answer input picture as a posting destination picture through which to respond to the second question; and
displaying the guide destination picture based on the guide information selected by the second user among pieces of guide information posted in the posting destination picture.

9. The computer-readable storage medium according to claim 8, wherein the electronic bulletin board control program causes the computer to execute:
storing contents of an answer as answer history information when the answer is input to an answer input picture; and
displaying the answer history information in an answer input picture that has been displayed based on guide information and is different from the answer input picture in which the answer has been input.

10. The computer-readable storage medium according to claim 8, wherein the electronic bulletin board control program causes the computer to execute:
storing, as part of an unanswered guide information history, unselected guide information among the posted pieces of guide information; and
posting the unselected guide information in the guide destination picture to which guidance has been made by the selected guide information, based on the unanswered guide information history.

11. The computer-readable storage medium according to claim 8, wherein the guide information generating operation comprises:
a posting destination candidates selecting operation of selecting a minimum number of second questions having high similarity with the first question within a range that an expected value of a number of times of reading of the first question in a prescribed period becomes greater than or equal to a prescribed value, and employing the selected second questions as posting destination candidates to be posted in posting destination pictures; and
a posting destination candidates correlating operation of generating pieces of guide information by correlating the posting destination candidates with the first question.

12. The computer-readable storage medium according to claim 8, wherein the guide information generating operation comprises:
a posting destination candidates selecting operation of selecting a minimum number of second questions having high similarity with the first question within a range that an expected value of the number of answers in a prescribed period becomes greater than or equal to a prescribed value, and employing the selected second questions as posting destination candidates to be posted in posting destination pictures; and
a posting destination candidates correlating operation of generating pieces of guide information by correlating the posting destination candidates with the first question.

13. The computer-readable storage medium according to claim 12, wherein the posting destination candidates selecting operation re-selects, as posting destination candidates, a minimum number of second questions that having high similarity with the first question within a range that a sum of an expected value of the number of answers in a prescribed period and a number of current answers becomes greater than or equal to a prescribed value.

14. The computer-readable storage medium according to claim 8, wherein the electronic bulletin board control program causes the computer to execute a guide information deleting operation of deleting pieces of guide information for guidance to the first question if the number of answers to the first question is larger than or equal to a prescribed number.

15. An electronic bulletin board control method for causing a second user to answer a question of a first user using an answer input picture, comprising:
generating guide information for guiding the second user to an answer input picture as a guide destination picture through which to respond to a first question of the first user, based on a second question that is similar to the first question;
posting the guide information in an answer input picture as a posting destination picture through which to respond to the second question; and
displaying the guide destination picture based on the guide information selected by the second user among pieces of guide information posted in the posting destination picture.

16. The electronic bulletin board control method according to claim 15, comprising:
storing contents of an answer as answer history information when the answer is input to an answer input picture; and
displaying the answer history information in an answer input picture that has been displayed based on guide information and is different from the answer input picture in which the answer has been input.

17. The electronic bulletin board control method according to claim 15, comprising:
storing, as part of an unanswered guide information history, unselected guide information among the posted pieces of guide information; and
posting the unselected guide information in the guide destination picture to which guidance has been made by the selected guide information, based on the unanswered guide information history.

18. The electronic bulletin board control method according to claim 15, wherein the guide information generating operation comprises the suboperations of:
selecting a minimum number of second questions having high similarity with the first question within a range that an expected value of a number of times of reading of the first question in a prescribed period becomes greater than or equal to a prescribed value, and employing the selected second questions as posting destination candidates to be posted in posting destination pictures; and
generating pieces of guide information by correlating the posting destination candidates with the first question.

19. The electronic bulletin board control method according to claim 15, wherein the guide information generating operation comprises the suboperations of:
selecting a minimum number of second questions having high similarity with the first question within a range that an expected value of the number of answers in a prescribed period becomes greater than or equal to a prescribed value, and employing the selected second questions as posting destination candidates to be posted in posting destination pictures; and
generating pieces of guide information by correlating the posting destination candidates with the first question.

20. The electronic bulletin board control method according to claim 19, wherein the posting destination candidates selecting re-selects, as posting destination candidates, a minimum number of second questions having high similarity with the first question within a range that a sum of an expected value of the number of answers in a prescribed period and the number of current answers becomes greater than or equal to a prescribed value.
